(19) United States
(12) Patent Application Publication
(10) Pub. No.: US 2026/0321457 A1
(43) Pub. Date: Oct. 15, 2026

(54) HIGH-VOLTAGE COAXIAL CABLE FOR NUCLEAR POWER PLANT

(71) Applicant: Guangzhou Changjiang New Energy Technology Co., Ltd, Guangzhou (CN)

(72) Inventors: Xuefeng LIU, Guangzhou (CN); Zhifeng YAO, Guangzhou (CN); Zhiliang CHEN, Guangzhou (CN)

(73) Assignee: Guangzhou Changjiang New Energy Technology Co., Ltd, Guangzhou (CN)

(21) Appl. No.: 19/174,818

(22) Filed: Apr. 9, 2025

(51) Int. Cl. H01B 7/22; H01B 7/295

(52) U.S. Cl. CPC H01B 7/228; H01B 7/295

(57) ABSTRACT

A high-voltage coaxial cable for the nuclear power plant includes a conductor, an insulating layer, a braided layer and a sheath layer. The insulating layer covers the conductor, the braided layer covers the insulating layer, the sheath layer covers the braided layer. The conductor, the insulating layer, the braided layer and the sheath layer are arranged coaxially, and a ratio of a diameter of the conductor to a thickness of the insulating layer, a thickness of the braided layer and a thickness of the sheath layer is (2.0-8.0):(1.1-2.3):(0.1-0.3):(0.8-1.5), and the diameter of the conductor is in a range of 2 mm to 8 mm. The high-voltage coaxial cable for the nuclear power plant has good resistance to high voltage.

### TECHNICAL FIELD

The present disclosure relates to the field of cables for nuclear power plants, and in particular to a high-voltage coaxial cable for a nuclear power plant.

### BACKGROUND

Cables for nuclear power plants are widely used in windings of nuclear power plants, and since such cables are used in special environments of nuclear power plants, they are often required to have such technical indicators as long thermal life, resistance to radiation, high flame resistance, resistance to high voltage, high transmission efficiency and environmental friendliness. Nuclear power plants generally operate for 24 hours a day and remain in operation for decades, therefore, the transmission efficiency of cables has a great impact on the efficiency of nuclear power plants. The voltage used in nuclear power plants is as high as tens of kilovolts, therefore, cables are required to be resistant to high voltage. The existing conventional cables for nuclear power plants are not able to satisfy these requirements simultaneously, especially the technical requirements of resistance to high voltage.

### SUMMARY

Aiming at the shortcomings of the prior art, the present disclosure aims to provide a high-voltage coaxial cable for a nuclear power plant, and the high-voltage coaxial cable is capable of withstanding high voltage.

In order to achieve the object of the present disclosure, the present disclosure provides a high-voltage coaxial cable for a nuclear power plant, wherein the high-voltage coaxial cable includes a conductor, an insulating layer, a braided layer and a sheath layer, the insulating layer covers the conductor, the braided layer covers the insulating layer, the sheath layer covers the braided layer, the conductor, the insulating layer, the braided layer and the sheath layer are arranged coaxially, a ratio of a diameter of the conductor to a thickness of the insulating layer, a thickness of the braided layer and a thickness of the sheath layer is (2.0-8.0):(1.1-2.3):(0.1-0.3):(0.8-1.5), and the diameter of the conductor is greater than 2.0 mm.

Further, the ratio of the diameter of the conductor to the thickness of the insulating layer, the thickness of the braided layer and the thickness of the sheath layer is (2.0-8.0):(1.17-1.43):(0.24-0.26):(0.8-1.2).

Further, an outer diameter of the sheath layer is 10 mm to 11.0 mm; an outer diameter of the braided layer is 8.0 mm to 9.0 mm; and an outer diameter of the insulating layer is 7.0 mm to 7.5 mm.

Further, the conductor is made of copper; the braided layer is made of copper; the conductor is composed of a single copper wire core or a plurality of strands of copper wire cores; and the diameter of the conductor is 2.0 mm to 8.0 mm.

Further, a direct current (DC) resistance of the conductor is less than or equal to 1.1 Ω/km; and a DC resistance of the braided layer is less than or equal to 1.67 Ω/km.

Further, a loop resistance of the conductor and the braided layer is less than or equal to 3 Ω/km; and the DC resistance of the braided layer is less than or equal to 2.64 Ω/km.

Further, a pitch of the braided layer is 40 mm to 80 mm.

Further, the braided layer includes a first braided layer and a second braided layer, wherein the first braided layer covers the insulating layer, and the second braided layer covers the first braided layer.

Further, a ratio of the diameter of the conductor to the thickness of the insulating layer, thickness of the first braided layer, a thickness of the second braided layer, and the thickness of the sheath layer is (2.0-8.0):(1.17-2.2):(0.16-0.26):(0.16-0.26):(0.8-1.2).

Further, the outer diameter of the sheath layer is 10 mm to 11 mm; an outer diameter of the second braided layer is 8.3 mm to 9 mm; an outer diameter of the first braided layer is 7.8 mm to 8 mm; and the outer diameter of the insulating layer is 7 mm to 7.5 mm.

Further, the conductor is made of copper; both the first braided layer and the second braided layer are made of copper; the conductor is composed of a single copper wire core or a plurality of strands of copper wire cores; and the diameter of the conductor is 2.0 mm to 8.0 mm.

Further, the loop resistance of the conductor and the braided layer is less than or equal to 3 Ω/km; and a total DC resistance of the first braided layer and the second braided layer is less than or equal to 2.64 Ω/km.

Further, a pitch of the first braided layer and the second braided layer is 40 mm to 80 mm.

Further, the insulating layer is made of modified cross-linked polyolefin, a volume resistance of the insulating layer is greater than or equal to 10¹⁵ Ω·m, and the sheath layer is made of a halogen-free flame retardant material, polyvinyl chloride or a thermoplastic polyurethane elastomer.

Further, the insulating layer is made of modified cross-linked polyolefin, and the volume resistance of the insulating layer is greater than or equal to 10¹⁵ Ω·m.

Further, the sheath layer is made of a halogen-free flame retardant material, polyvinyl chloride or a thermoplastic polyurethane elastomer.

Further, a concentricity of the sheath layer is greater than or equal to 80%.

Compared with the prior art, the present disclosure is capable of achieving the following beneficial effects.

The high-voltage coaxial cable for the nuclear power plant of the present disclosure includes a conductor, an insulating layer, a braided layer and a sheath layer which are arranged in sequence from inside to outside, and limits the sizes and proportions of the four components, therefore, the high-voltage coaxial cable may improve the current loading capacity of the cable and is resistant to high voltage, and may be used at a voltage of 40 kV DC for 5 min without breakdown.

### BRIEF DESCRIPTION OF THE DRAWINGS

FIG. 1 is a cross-sectional diagram of the high-voltage coaxial cable for the nuclear power plant of the present disclosure when a braided layer of the cable is single-layered.

FIG. 2 is a cross-sectional diagram of the high-voltage coaxial cable for the nuclear power plant of the present disclosure when a braided layer of the cable is double-layered.

The present disclosure is described in further detail below in combination with the accompanying drawings and specific embodiments.

### DETAILED DESCRIPTION OF THE EMBODIMENTS

Embodiments of the present disclosure provide a high-voltage coaxial cable for a nuclear power plant, and the high-voltage coaxial cable for the nuclear power plant is particularly suitable for use in windings of nuclear power plants, and is capable of satisfying the operation requirements of nuclear power plants. Owing to its property of resistance to high voltage, the high-voltage coaxial cable for the nuclear power plant may be used at a voltage of 40 kV DC for 5 min without breakdown. Of course, the high-voltage coaxial cable for the nuclear power plant of the embodiments of the present disclosure may also be used for other high-voltage applications other than windings of the nuclear power plants.

Specifically, the high-voltage coaxial cable for the nuclear power plant of this embodiment includes a conductor 1, an insulating layer 2, a braided layer 3, and a sheath layer 4, wherein the insulating layer 2 covers the conductor 1, the braided layer 3 covers the insulating layer 2, and the sheath layer 4 covers the braided layer 3, so as to form a structure in which one layer is sleeved on another layer. The conductor 1 is located in the centre of the cable, and the insulating layer 2, the braided layer 3, and the sheath layer 4 are arranged on the outer side of the conductor 1 in sequence.

The conductor 1, the insulating layer 2, the braided layer 3 and the sheath layer 4 are arranged coaxially, i.e., in the cross section of the cable, the central axis of the conductor 1, the central axis of the insulating layer 2, the central axis of the braided layer 3 and the central axis of the sheath layer 4 coincide or substantially coincide, exhibiting negligible eccentricity.

The ratio of the diameter of the conductor 1 to the thickness of the insulating layer 2, the thickness of the braided layer 3, and the thickness of the sheath layer 4 is (2.0-8.0):(1.1-1.5):(0.2-0.3):(0.8-1.5), and the diameter of the conductor 1 is greater than 2 mm. When the sizes of the conductor 1, the insulating layer 2, the braided layer 3, and the sheath layer 4 satisfy the above conditions, the conductor 1 has a small resistance and a high current loading capacity, and the insulating layer 2, the braided layer 3 and the sheath layer 4 are capable of well protecting the conductor 1, and may be used at a voltage of 40 kV DC for 5 min without breakdown, thereby satisfying the application requirements of windings of the nuclear power plants. Moreover, the cable is capable of maintaining flexibility and small size, and is convenient for winding and flexible in applications.

The conductor 1 is made of the existing conductive materials. The conductor 1 has a diameter of greater than 2 mm and may basically satisfy the application requirements of windings of nuclear power plants. The diameter of the conductor 1 may be for example 2.0 mm to 8.0 mm, a diameter below this range may lead to increased resistance and reduced current loading capacity of the conductor 1, while a diameter exceeding this range may influence the flexibility of the conductor 1.

In some embodiments, the conductive material may be for example copper. Copper is readily available as a raw material and is low in cost. The conductor 1 may be composed of a single copper wire core or a plurality of strands of copper wire cores, the structure is simple. Moreover, compared with a copper wire core formed by winding a plurality of copper wires, a single copper wire core may further reduce the resistance of the conductor 1.

In some embodiments, the DC resistance of the conductor 1 is less than or equal to 1.1 Ω/km, and the conductor 1 has a high current loading capacity and may be used in high-voltage applications.

The insulating layer 2 may be made of an existing insulating material. When the ratio of the diameter of the conductor 1 to the thickness of the insulating layer 2 is in a range of (2.0-8.0): (1.1-1.5), the insulating layer 2 is able to provide good dielectric insulation safety protection and mechanical protection for the conductor 1. A too-thin insulating layer 2 may lead to a risk of electric leakage and electric breakdown, and a too-thick insulating layer 2 may result in overhigh costs and too much space occupied by the cables.

In some embodiments, the insulating material may be, for example, modified cross-linked polyolefin, particularly radiation cross-linked polyethylene. Radiation cross-linked polyethylene is formed by crosslinking polyethylene under irradiation conditions, and covalent bonds are formed between polyethylene molecular chains. The radiation cross-linked polyethylene exhibits good insulating properties, reduces the possibility of electric leakage, and protects the cable from electric breakdown under high voltage, and the radiation cross-linked polyethylene has good mechanical property, heat resistance and irradiation resistance, improves the overall mechanical strength and heat resistance of the cable, and is irradiation-resistant, thereby being particularly suitable for use in nuclear power plants.

The braided layer 3 may be made of fibers or conductive wires. When the ratio of the diameter of the conductor 1 to the thickness of the braided layer 3 is in a range of (2.0-8.0):(0.2-0.3), the braided layer 3 is able to provide a good shielding effect, with a shielding rate of 92%. When the thickness of the braided layer 3 is too small, the shielding capacity is insufficient, and when the thickness is too large,

In some embodiments, the braided layer 3 is formed by braiding copper wires. The braided layer 3 made of copper wires provides mechanical protection to the cable and enhances mechanical strength of the cable; the braided layer 3 is capable of shielding electromagnetic interference, and is especially suitable for use in windings of nuclear power plants. Additionally, the braided layer 3 eliminates the surface potential of the power cable and eliminates induced electricity, and may also be used as a ground wire to dredge leakage current in time and play a role in safety protection.

In some embodiments, the braided layer 3 may also be wound with a wrapping tape for further protection.

In some embodiments, the DC resistance of the braided layer is less than or equal to 1.67 Ω/km, and the braided layer is able to better dredge possible leakage current.

In some embodiments, the pitch of the braided layer is 40 mm to 80 mm, thereby being beneficial for reducing the resistance of the braided layer.

The sheath layer 4 may be made of a halogen-free flame retardant material, polyvinyl chloride or a thermoplastic polyurethane elastomer. The sheath layer 4 is wrapped around the outer side of the braided layer 3, to play a role in protection. The ratio of the diameter of the conductor 1 to the thickness of the braided layer 3 is in a range of (4.3-4.6): (0.8-1.5), and the sheath layer 4 is capable of providing a good protective effect.

In some embodiments, the sheath layer 4 is made of a halogen-free flame retardant material, polyvinyl chloride, or a thermoplastic polyurethane elastomer, and the sheath layer 4 is preferably made of a thermoplastic elastomer, and the sheath layer 4 has a certain degree of flexibility to facilitate bending and winding of the cable.

In some embodiments, the concentricity of the sheath layer 4 is greater than or equal to 80%, and the sheath layer 4 is capable of providing uniform protection.

In some embodiments, the cable is merely composed of a conductor 1, an insulating layer 2, a braided layer 3, and a sheath layer 4, and does not contain any other layers other than the four layers mentioned above.

In some embodiments, two adjacent layers among the conductor 1, the insulating layer 2, the braided layer 3, and the sheath layer 4 are in close contact. In some other examples, gaps are allowed between two adjacent layers among the conductor 1, the insulating layer 2, the braided layer 3 and the sheath layer 4.

In some embodiments, the ratio of the diameter of the conductor 1 to the thickness of the insulating layer 2, the thickness of the braided layer 3, and the thickness of the sheath layer 4 is (2.0-8.0):(1.17-1.43):(0.24-0.26):(0.8-1.2). Within the above ratio range, the cable is capable of better satisfying the use requirements of windings of the nuclear power plants owing to its current loading capacity, resistance to high voltage, radiation resistance and heat resistance.

In some embodiments, the outer diameter of the sheath layer 4 is 10 mm to 11 mm; and/or the outer diameter of the braided layer 3 is 8 mm to 9 mm; and/or the outer diameter of the insulating layer 2 is 7 mm to 7.5 mm. When the outer diameters of the insulating layer 2, the braided layer 3, and the sheath layer 4 are in the above ranges, the size of the cable may be reduced, and the functions of each of the layers is maintained.

In some embodiments, the outer diameter of the sheath layer 4 is 10.0 mm to 11.0 mm; and/or the outer diameter of the braided layer 3 is 8.3 mm to 8.5 mm; and/or the outer diameter of the insulating layer 2 is 7.1 mm to 7.4 mm. The functions of the cable are better when the outer diameters of the insulating layer 2, the braided layer 3, and the sheath layer 4 are in the above ranges.

In some embodiments, the insulating layer 2 and the sheath layer 4 are each made of a halogen-free flame retardant material, and the halogen-free flame retardant material may be the existing halogen-free flame retardant plastics to improve the flame resistance of the cable, and the cable will not produce halogen-containing toxic gases even if it burns.

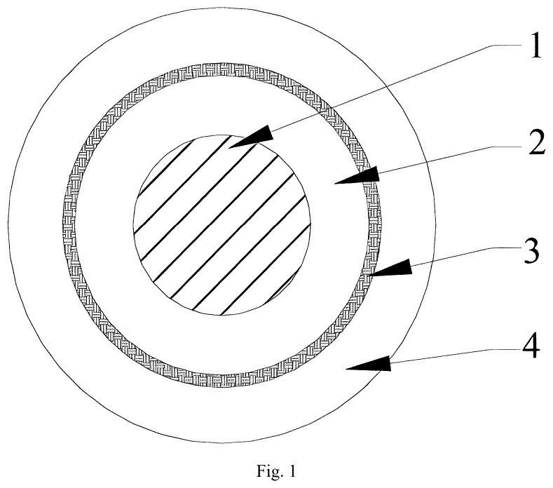

In some embodiments, as shown in FIG. 1, specific parameters of each part of the cable are as follows:
the conductor 1 is a single bare copper wire core with a diameter of 4.46±0.02 mm; the insulating layer 2 is made of XLPE-018, the average thickness of the insulating layer 2 is 1.3 mm, the minimum thickness of the insulating layer 2 is 1.17 mm, the concentricity of the insulating layer 2 is at least greater than 90%, and the outer diameter of the insulating layer 2 is 7.25+0.20/−0 mm;
the braided layer 3 is formed by braiding bare copper, the number of braiding spindles of the braided layer 3 is 24, the number of wires per spindle is 9, the diameter of an individual braided wire is 0.254±0.006 mm, the shielding ratio of the braided layer 3 is 92%, the pitch of the braided layer 3 is 76.27 mm, and the outer diameter of the braided layer 3 is 8.3 mm;
the sheath layer 4 is made of PE- 016, the average thickness of the sheath layer 4 is 1 mm, the minimum thickness of the sheath layer 4 is 0.8 mm, the concentricity of the sheath layer 4 is at least greater than 80%, and the outer diameter of the sheath layer 4 is 10.5±0.2 mm;
the characteristic impedance of the cable is greater than or equal to 18 Ω, the DC resistance (20 °C) of the conductor 1 is less than or equal to 1.1 Ω/km, and the DC resistance (20 °C) of the braided layer 3 is less than or equal to 1.67 Ω/km;
the insulating layer 2 is required to pass a spark test at 8 kV, and the sheath layer 4 is required to pass a spark test at 6 kV; and
the adhesive force of the insulating layer 2 to the conductor 1 is greater than or equal to 3 kg.

Next, a cable structure with double braided layers is shown, specifically, the high-voltage coaxial cable for the nuclear power plant of this embodiment includes a conductor 1, an insulating layer 2, a first braided layer 31, a second braided layer 32, and a sheath layer 4, wherein the insulating layer 2 covers the conductor 1, the first braided layer 31 covers the insulating layer 2, the second braided layer 32 covers the first braided layer 31, and the sheath layer 4 covers the second braided layer 32, to form a structure in which one layer is sleeved on another layer. The conductor 1 is located in the centre of the cable, and the insulating layer 2, the first braided layer 31, the second braided layer 32, and the sheath layer 4 are arranged on the outer side of the conductor 1 in sequence.

The conductor 1, the insulating layer 2, the first braided layer 31, the second braided layer 32 and the sheath layer 4 are arranged coaxially, i.e., in the cross section of the cable, the central axis of the conductor 1, the central axis of the insulating layer 2, the central axis of the first braided layer 31, the central axis of the second braided layer 32 and the central axis of the sheath layer 4 coincide or substantially coincide, exhibiting negligible eccentricity.

The ratio of the diameter of the conductor 1 to the thickness of the insulating layer 2, the thickness of the first braided layer 31, the thickness of the second braided layer 32, and the thickness of the sheath layer 4 is (2.65-2.73):(1.17-2.2):(0.16-0.26):(0.16-0.26):(0.8-1.2), and the diameter of the conductor 1 is greater than 2.6 mm. When the sizes of the conductor 1, the insulating layer 2, the first braided layer 31, the second braided layer 32 and the sheath layer 4 satisfy the above conditions, the conductor 1 has a small resistance and a high current loading capacity, and the insulating layer 2, the first braided layer 31, the second braided layer 32 and the sheath layer 4 are capable of well protecting the conductor 1, and may be used at a voltage of 40 kV DC for 5 min without breakdown, thereby satisfying the application requirements of windings of the nuclear power plants. Moreover, the cable is capable of maintaining flexibility and small size, and is convenient for winding and flexible in applications.

Moreover, the first braided layer 31 and the second braided layer 32 are not merely shielding layers, they have low resistance and are capable of satisfying the grounding requirements.

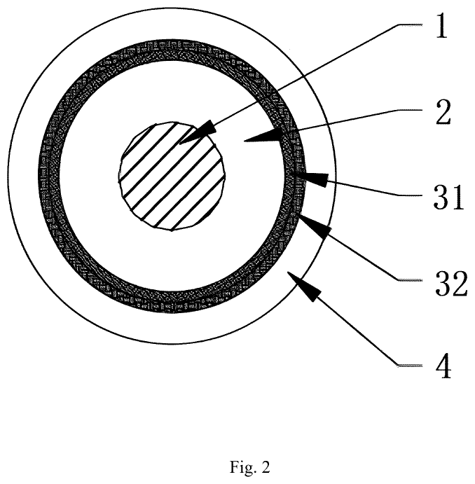

In some embodiments, as shown in FIG. 2, specific parameters of each part of the cable are as follows:
the conductor 1 is a single bare copper wire core with a diameter of 2.69±0.04 mm;
the insulating layer 2 is made of XLPE-018, the average thickness of the insulating layer 2 is 2.2 mm, and the outer diameter of the insulating layer 2 is 7.25±0.15 mm;
the first braided layer 31 is formed by braiding bare copper, the number of braiding spindles of the braided layer 3 is 16, the number of wires per spindle is 11, the diameter of an individual braided wire is 0.16±0.002 mm, the shielding ratio of the braided layer 3 is 93%, the pitch of the braided layer 3 is 41.43 mm, and the outer diameter of the braided layer 3 is 7.9 mm;
the second braided layer 32 is formed by braiding bare copper, the number of braiding spindles of the braided layer 3 is 16, the number of wires per spindle is 11, the diameter of an individual braided wire is 0.16±0.002 mm, the shielding ratio of the braided layer 3 is 93%, the pitch of the braided layer 3 is 41.86 mm, and the outer diameter of the braided layer 3 is 8.5 mm;
the sheath layer 4 is made of PVC-KO-174, the average thickness of the sheath layer 4 is 0.94 mm, and the outer diameter of the sheath layer 4 is 10.5±0.2 mm;
the characteristic impedance of the cable is greater than or equal to 32 Ω, the DC resistance (20 °C) of the conductor 1 is less than or equal to 3 Ω/km, and the total DC resistance (20 °C) of the first braided layer 31 and the second braided layer 32 is less than or equal to 2.64 Ω/km;
the insulating layer needs to withstand an AC voltage of 20 kV without breakdown, the insulating layer 2 needs to pass a spark test at 8 kV, and the sheath layer 4 needs to pass a spark test at 6 kV; and
the adhesive force of the insulating layer 2 to the conductor 1 is greater than or equal 2.5 kg.

Finally, it should be emphasized that the above are merely preferred embodiments of the present disclosure and are not intended to limit the present disclosure. Any modifications, equivalent substitutions, improvements and the like made within the spirit and principles of the present disclosure shall all fall within the protection scope of the present disclosure.

What is claimed is:

1. A high-voltage coaxial cable for a nuclear power plant, comprising a conductor, an insulating layer, a braided layer and a sheath layer, wherein
the insulating layer covers the conductor, the braided layer covers the insulating layer, the sheath layer covers the braided layer;
the conductor, the insulating layer, the braided layer and the sheath layer are arranged coaxially; and
a ratio of a diameter of the conductor to a thickness of the insulating layer, a thickness of the braided layer and a thickness of the sheath layer is (2.0-8.0):(1.1-2.3):(0.1-0.3):(0.8-1.5), and the diameter of the conductor is greater than 2.0 mm.

2. The high-voltage coaxial cable for the nuclear power plant according to claim 1, wherein the ratio of the diameter of the conductor to the thickness of the insulating layer, the thickness of the braided layer, and the thickness of the sheath layer is (2.0-8.0):(1.17-1.43):(0.24-0.26):(0.8-1.2).

3. The high-voltage coaxial cable for the nuclear power plant according to claim 1, wherein an outer diameter of the sheath layer is 10 mm to 11 mm;
an outer diameter of the braided layer is 8.0 mm to 9.0 mm; and
an outer diameter of the insulating layer is 7.0 mm to 7.5 mm.

4. The high-voltage coaxial cable for the nuclear power plant according to claim 1, wherein the conductor is made of copper;
the braided layer is made of copper;
the conductor is composed of a single copper wire core or a plurality of strands of copper wire cores; and
the diameter of the conductor is 2.0 mm to 8.0 mm.

5. The high-voltage coaxial cable for the nuclear power plant according to claim 1, wherein a direct current (DC) resistance of the conductor is less than or equal to 1.1 Ω/km; and
a DC resistance of the braided layer is less than or equal to 1.67 Ω/km.

6. The high-voltage coaxial cable for the nuclear power plant according to claim 1, wherein a loop resistance of the conductor and the braided layer is less than or equal to 3 Ω/km; and
the DC resistance of the braided layer is less than or equal to 2.64 Ω/km.

7. The high-voltage coaxial cable for the nuclear power plant according to claim 1, wherein a pitch of the braided layer is 40 mm to 80 mm.

8. The high-voltage coaxial cable for the nuclear power plant according to claim 1, wherein the braided layer comprises a first braided layer and a second braided layer, the first braided layer covers the insulating layer, and the second braided layer covers the first braided layer.

9. The high-voltage coaxial cable for the nuclear power plant according to claim 8, wherein a ratio of the diameter of the conductor to the thickness of the insulating layer, a thickness of the first braided layer, a thickness of the second braided layer, and the thickness of the sheath layer is (2.0-8.0):(1.17-2.2):(0.16-0.26):(0.16-0.26):(0.8-1.2).

10. The high-voltage coaxial cable for the nuclear power plant according to claim 8, wherein the outer diameter of the sheath layer is 10 mm to 11 mm;
an outer diameter of the second braided layer is 8.3 mm to 9 mm;
an outer diameter of the first braided layer is 7.8 mm to 8 mm; and
the outer diameter of the insulating layer is 7 mm to 7.5 mm.

11. The high-voltage coaxial cable for the nuclear power plant according to claim 8, wherein the conductor is made of copper;
both the first braided layer and the second braided layer are made of copper;
the conductor is composed of a single copper wire core or a plurality of strands of copper wire cores; and
the diameter of the conductor is 2.0 mm to 8.0 mm.

12. The high-voltage coaxial cable for the nuclear power plant according to claim 8, wherein the loop resistance of the conductor and the braided layer is less than or equal to 3 Ω/km; and
a total DC resistance of the first braided layer and the second braided layer is less than or equal to 2.64 Ω/km.

13. The high-voltage coaxial cable for the nuclear power plant according to claim 8, wherein a pitch of the first braided layer and the second braided layer is 40 mm to 80 mm.

14. The high-voltage coaxial cable for the nuclear power plant according to claim 1, wherein the insulating layer is made of modified cross-linked polyolefin, a volume resistance of the insulating layer is greater than or equal to 10¹⁵ Ω·m, and the sheath layer is made of a halogen-free flame retardant material, polyvinyl chloride or a thermoplastic polyurethane elastomer.

15. The high-voltage coaxial cable for the nuclear power plant according to claim 1, wherein the insulating layer is made of modified cross-linked polyolefin, and the volume resistance of the insulating layer is greater than or equal to 10¹⁵ Ω·m.

16. The high-voltage coaxial cable for the nuclear power plant according to claim 1, wherein the sheath layer is made of a halogen-free flame retardant material, polyvinyl chloride or a thermoplastic polyurethane elastomer.

17. The high-voltage coaxial cable for the nuclear power plant according to claim 1, wherein a concentricity of the sheath layer is greater than or equal to 80%.
